(19) United States
(12) Patent Application Publication
(10) Pub. No.: US 2024/0195710 A1
(43) Pub. Date: Jun. 13, 2024

(54) MULTI-DOMAIN COOPERATIVE NETWORK ANALYTICS

(71) Applicant: Nokia Technologies Oy, Espoo (FI)

(72) Inventors: Stephen MWANJE, Munich (DE); Muhammad NASEER-UL-ISLAM, Munich (DE); Uwe RAUSCHENBACH, Munich (DE)

(21) Appl. No.: 18/555,312

(22) PCT Filed: May 25, 2021
(86) PCT No.: PCT/EP2021/063828

§ 371 Date: Oct. 13, 2023

(51) Int. Cl. H04L 41/5025; H04L 41/5009; H04W 24/08

(52) U.S. Cl. CPC H04L 41/5025; H04L 41/5009; H04W 24/08

(57) ABSTRACT

Various example embodiments relate to cooperative analytics across multiple network management domains. An apparatus may request management domain analytics from a plurality of management domains of a communication network. The apparatus may receive management domain analytics results from the plurality of management domains and cause reconfiguration of the communication network based on the management domain analytics results. Apparatuses, methods, and computer programs are disclosed.

### TECHNICAL FIELD

Various example embodiments generally relate to the field of wireless communications. Some example embodiments relate to cooperative analytics across multiple network management domains.

### BACKGROUND

End-to-end (E2E) lifecycle management (LCM) of communication services may involve multiple management processes relying on integration between an E2E service management domain (E2E SMD) and multiple management domains (MD) that may work together to fulfil the desired communication services. Capabilities of such systems to analyse and manage communication services may be however further improved.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. The scope of protection sought for various embodiments of the present disclosure is set out by the independent claims.

Example embodiments of the present disclosure enable coordination of analytics services between a centralized service management domain and individual management domains. This and other benefits may be achieved by the features of the independent claims. Further advantageous implementation forms are provided in the dependent claims, the description, and the drawings.

According to a first aspect, an apparatus may comprise at least one processor and at least one memory including computer program code, the at least one memory and the computer code configured to, with the at least one processor, cause the apparatus at least to: request, by a service management domain of a communication network, management domain analytics from a plurality of management domains of the communication network; receive management domain analytics results from the plurality of management domains; analyse the management domain analytics results in combination with service data and/or service analytics of the service management domain; and cause reconfiguration of the communication network based on the analysis of the management domain analytics results in combination with the service data and/or the service analytics of the service management domain.

According to an example embodiment of the first aspect, the computer code may be further configured to, with the at least one processor, cause the apparatus to: request the management domain analytics from at least one of the plurality of management domains based on a predetermined schedule and/or in response to detecting expiry of a timer.

According to an example embodiment of the first aspect, the computer code may be further configured to, with the at least one processor, cause the apparatus to: request the management domain analytics from at least one of the plurality of management domains in response to detecting a triggering condition indicative of at least one communication performance issue at the communication network.

According to an example embodiment of the first aspect, the computer code may be further configured to, with the at least one processor, cause the apparatus to: determine the management domain analytics based on a type of the at least one communication performance issue.

According to an example embodiment of the first aspect, the computer code may be further configured to, with the at least one processor, cause the apparatus to: send a configuration of the management domain analytics to the at least one of the plurality of management domains.

According to an example embodiment of the first aspect, the computer code may be further configured to, with the at least one processor, cause the apparatus to: send a request for the management domain analytics to the at least one of the plurality of management domains.

According to an example embodiment of the first aspect, the computer code may be further configured to, with the at least one processor, cause the apparatus to: discover the management domain analytics via at least one integration fabric associated with the plurality of management domains.

According to an example embodiment of the first aspect, the computer code may be further configured to, with the at least one processor, cause the apparatus to: send a request for the management domain analytics to the at least one integration fabric.

According to an example embodiment of the first aspect, the computer code may be further configured to, with the at least one processor, cause the apparatus to: collect, from the at least one of the plurality of management domains, management domain data associated with the at least one communication performance issue; and cause the reconfiguration of the communication network further based on the management domain data.

According to an example embodiment of the first aspect, the computer code may be further configured to, with the at least one processor, cause the apparatus to: discover, via the at least one integration fabric associated with the plurality of management domains, at least one data collection service for the collection of the management domain data.

According to an example embodiment of the first aspect, the computer code may be further configured to, with the at least one processor, cause the apparatus to: send a configuration of the at least one data collection service to the at least one of the plurality of management domain.

According to an example embodiment of the first aspect, the computer code may be further configured to, with the at least one processor, cause the apparatus to: subscribe to at least one data channel; and receive the management domain data from the at least one integration fabric via the at least one data channel.

According to an example embodiment of the first aspect, the computer code may be further configured to, with the at least one processor, cause the apparatus to: request the management domain data from the at least one of the plurality of management domains; and receive the management domain data from the at least one of the plurality of management domains.

According to an example embodiment of the first aspect, the management domain data may comprise updated management domain data, wherein at least one performance indicator of the updated management domain data is different from previously collected management domain data, and/or wherein a granularity of the at least one performance indicator of the updated management domain data is different from the previously collected management domain data.

According to an example embodiment of the first aspect, the at least one integration fabric may comprise a cross-domain integration fabric associated with the plurality of management domains or a plurality of integration fabrics associated with respective management domains.

According to an example embodiment of the first aspect, the plurality of management domains may comprise at least one of: a radio access network management domain, a fixed access management domain, a transport management domain, a core network management domain, or a cloud management domain.

According to a second aspect, a method may comprise: requesting, by a service management domain of a communication network, management domain analytics from a plurality of management domains of the communication network; receiving management domain analytics results from the plurality of management domains; analysing the management domain analytics results in combination with service data and/or service analytics of the service management domain; and causing reconfiguration of the communication network based on the analysis of the management domain analytics results in combination with the service data and/or the service analytics of the service management domain.

According to an example embodiment of the second aspect, the method may further comprise: requesting the management domain analytics from at least one of the plurality of management domains based on a predetermined schedule and/or in response to detecting expiry of a timer.

According to an example embodiment of the second aspect, the method may further comprise: requesting the management domain analytics from at least one of the plurality of management domains in response to detecting a triggering condition indicative of at least one communication performance issue at the communication network.

According to an example embodiment of the second aspect, the method may further comprise: determining the management domain analytics based on a type of the at least one communication performance issue.

According to an example embodiment of the second aspect, the method may further comprise: sending a configuration of the management domain analytics to the at least one of the plurality of management domains.

According to an example embodiment of the second aspect, the method may further comprise: sending a request for the management domain analytics to the at least one of the plurality of management domains.

According to an example embodiment of the second aspect, the method may further comprise: discovering the management domain analytics via at least one integration fabric associated with the plurality of management domains.

According to an example embodiment of the second aspect, the method may further comprise: sending a request for the management domain analytics to the at least one integration fabric.

According to an example embodiment of the second aspect, the method may further comprise: collecting, from the at least one of the plurality of management domains, management domain data associated with the at least one communication performance issue; and causing the reconfiguration of the communication network further based on the management domain data.

According to an example embodiment of the second aspect, the method may further comprise: discovering, via the at least one integration fabric associated with the plurality of management domains, at least one data collection service for the collection of the management domain data.

According to an example embodiment of the second aspect, the method may further comprise: sending a configuration of the at least one data collection service to the at least one of the plurality of management domain.

According to an example embodiment of the second aspect, the method may further comprise: subscribing to at least one data channel; and receiving the management domain data from the at least one integration fabric via the at least one data channel.

According to an example embodiment of the second aspect, the method may further comprise: requesting the management domain data from the at least one of the plurality of management domains; and receiving the management domain data from the at least one of the plurality of management domains.

According to an example embodiment of the second aspect, the management domain data may comprise updated management domain data, wherein at least one performance indicator of the updated management domain data is different from previously collected management domain data, and/or wherein a granularity of the at least one performance indicator of the updated management domain data is different from the previously collected management domain data.

According to an example embodiment of the second aspect, the at least one integration fabric may comprise a cross-domain integration fabric associated with the plurality of management domains or a plurality of integration fabrics associated with respective management domains.

According to an example embodiment of the second aspect, the plurality of management domains may comprise at least one of: a radio access network management domain, a fixed access management domain, a transport management domain, a core network management domain, or a cloud management domain.

According to a third aspect, a computer program may comprise instructions for causing an apparatus to perform at least the following: requesting, by a service management domain of a communication network, management domain analytics from a plurality of management domains of the communication network; receiving management domain analytics results from the plurality of management domains; analysing the management domain analytics results in combination with service data and/or service analytics of the service management domain; and causing reconfiguration of the communication network based on the analysis of the management domain analytics results in combination with the service data and/or the service analytics of the service management domain. The computer program may further comprise instructions for causing the apparatus to perform any example embodiment of the method of the second aspect.

According to a fourth aspect, an apparatus may comprise means for requesting, by a service management domain of a communication network, management domain analytics from a plurality of management domains of the communication network; means for receiving management domain analytics results from the plurality of management domains; means for analysing the management domain analytics results in combination with service data and/or service analytics of the service management domain; and means for causing reconfiguration of the communication network based on the analysis of the management domain analytics results in combination with the service data and/or the service analytics of the service management domain. The apparatus may further comprise means for performing any example embodiment of the method of the second aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a network and service management architecture, according to an example embodiment;

FIG. 2 illustrates an example of an apparatus configured to practice one or more example embodiments;

FIG. 3 illustrates an example of a multi-domain assurance management architecture, according to an example embodiment;

FIG. 4 illustrates an example of a service quality management process, according to an example embodiment;

FIGS. 5A and 5B illustrate an example of a cooperative analytics process, according to an example embodiment; and

FIG. 6 illustrates an example of a method for cooperative service analytics, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

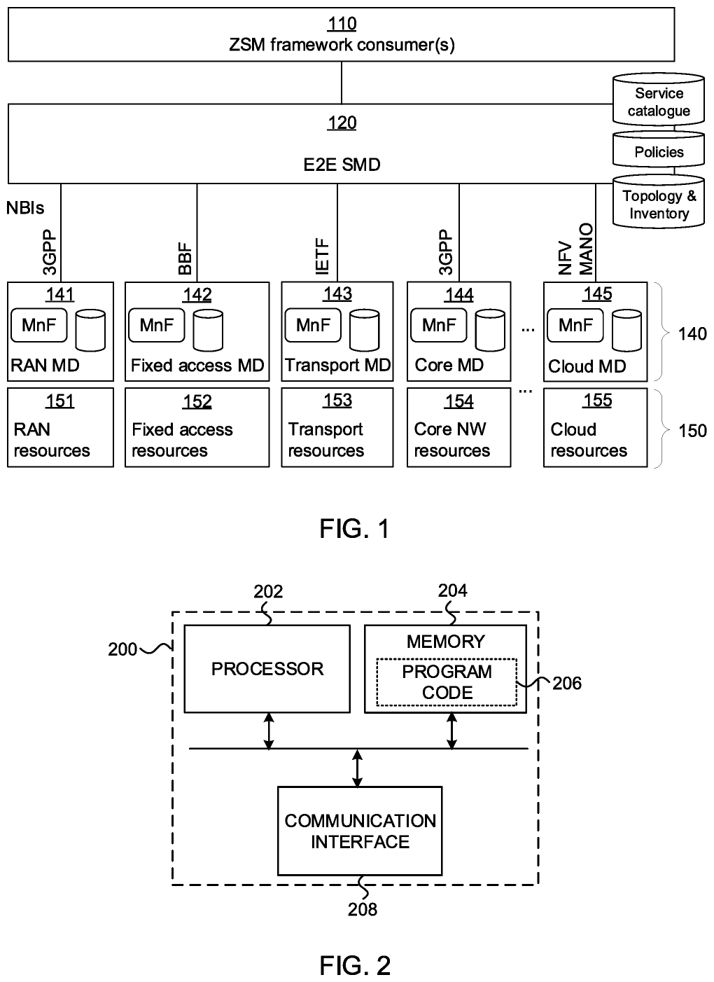

FIG. 1 illustrates an example of a network and service management architecture, according to an example embodiment. Cross-domain end-to-end (E2E) lifecycle management (LCM) of communication services may be organized for example based on the Zero Touch Network and Service Management (ZSM) framework, as currently being specified by the European Telecommunications Standards Institute (ETSI). The ZSM framework consumer(s) 110 may access network and service management services via a centralized service management domain, represented in this example by the E2E service management domain (SMD) 120. The E2E SMD 120 may perform cooperative network and service management functions for multiple management domains (MD) 140, for example a radio access network (RAN) MD 141, a fixed access MD 142, a transport MD 143, a core MD 144, a cloud MD 145, or the like. The management domains 140 may be associated with corresponding network resources 150, for example RAN resources 151, fixed access resources 152, transport resources 153, core network (NW) resources 154, and cloud resources (155), respectively. The RAN and core network managed by the RAN MD 141 and the core MD 144 may be may be configured according to 3rd generation partnership project (3GPP) specifications, for example the 5G New Radio (NR). The fixed access network managed by the fixed access MD 142 may be configured according to any suitable wired access technology. The transport network managed by the transport MD 143 may be configured for example according to IETF (internet engineering task force) specifications. The ZSM framework may be therefore used for service management withing a multi-domain communication network comprising, for example, a RAN, a fixed access network, and a core network. It is however noted that even though some example embodiments have been described in the context of the ZSM framework, the example embodiments may be alternatively applied in any other current or future network and service management system.

The E2E SMD 120 may comprise or be associated with a service catalogue, which may comprise information about services provided by the E2E SMD 120. The E2E SMD 120 may further comprise or be associated with one or more policies for the services indicated in the service catalogue. The E2E SMD 120 may further comprise or be associated with information about inventories of resources and domain services, and the related topologies in the management domains 140. In ZSM, a management domain may have different boundaries, for example organizational, geographical, administrative, or technological boundaries. It is however noted that the management domains 140 of FIG. 1 are provided as examples, and the E2E SMD 120 could be in general configured to manage any suitable number and type of management domains. For simplicity, the example of FIG. 1 is directed to different technology domains.

The different technology domains may expose management functions (MnF) or management services (MnS) via a set of north bound interfaces (NBI). For example, the RAN MD 131 may expose a 3GPP interface. The fixed access MD 132 may expose a broadband forum (BBF) interface. The transport MD 133 may expose an IETF interface. The core MD may expose another 3GPP interface. The cloud MD may expose a NFV (network function virtualization) MANO (management and network orchestration) interface. It is therefore noted that the E2E SMD 120 may cooperate with various different type of management functions and therefore solutions that aid the E2E SMD 120 in the management of these functions may be desired.

Any management process during the E2E service lifecycle may be based on the E2E SMD 120 consuming management services from the management domains 140. For example, E2E management processes may use orchestration services for service configuration, or data collection services to obtain performance data used to validate whether quality requirements are met for different services. The quality requirements may comprise for example a required bit rate or latency. The management services may depend on the technology used in the underlying management domains 140 and therefore the E2E SMD 120 may consume the various management services from the management domains 140 via endpoints that make up the northbound interface of a respective one of the management domains 140.

The E2E service lifecycle may be managed based on different processes. A first category of processes may include fulfilment processes, which may bring up a service instance based on an onboarded service model, configure the service instance, activate the service instance for use, and terminate it. A second category of processes may include assurance processes, which may ensure that a service is free of faults and fulfil its service quality management requirements. Fulfilment processes may be executed upon request. Assurance processes may be configured to be executed continuously, for example in closed loops. Examples of enhanced closed loop assurance processes are described herein.

For E2E service assurance, the E2E service assurance process may use data collection services of the management domains 140, for example in order to collect data for assurance processes. The collected data may be then analysed by the E2E SMD 120, for example to detect a performance issue. In the ZSM architecture, the E2E SMD 120 may be assumed to be capable of independently analysing the data collected from the management domains 140 to detect any possible problem. It may be however challenging for the E2E SMD 120 to diagnose problems that occur in the different management domains 140, for example because the E2E SMD 120 may not have the insight that each of the management domains 140 has about its resources and their interactions. Therefore, it may not be possible for the E2E SMD 120 to independently detect a performance issue, for example if the real cause requires analysis from the different perspectives of the individual management domains 140. Therefore, besides the analysis performed at the E2E SMD 120, it may be beneficial to leave some analysis to be done in the relevant management domains in order to get better insight into the problem. Therefore, the example embodiments of the present disclosure address means for detecting problems that may require perspectives of both the E2E SMD 120 and the individual management domains 140. For example, means for supporting cooperative analytics between the E2E SMD 120 and the lower level management domains 140 are disclosed.

According to an example embodiment, an apparatus, for example a network device implementing the E2E SMD 120, may request management domain analytics from a plurality of management domains of a communication network. The apparatus may receive management domain analytics results from the plurality of management domains and cause reconfiguration of the communication network based on the management domain analytics results. This enables the communication network to be reconfigured based on a cooperative analysis between different management functions and the service management domain (E2E SMD). The apparatus may further request more data from the management domains to improve the cooperative analysis.

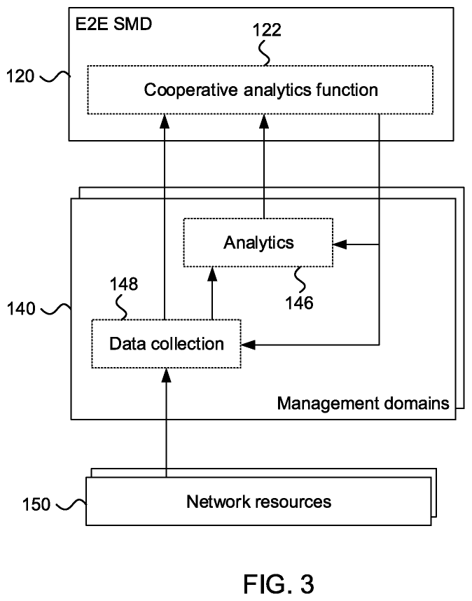

FIG. 2 illustrates an example embodiment of an apparatus 200, for example a network device or a network node configured to implement functionality of a service management domain (e.g. the E2E SMD 120) and/or one or more of the management domains 140. In general, the apparatus 200 may be configured to perform one or more network functions, for example according to the service-based architecture (SBA) of the 5th generation (5G) 3GPP standards. The apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special-purpose computer chip, or the like.

The apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable the apparatus to send and/or receive information, for example the network management related information described herein to/from other network devices, nodes, or functions. For example, the apparatus 200 may use the communication interface 208 to send or receive information over the service-based interface (SBI) message bus of the 5G SBA. The communication interface 208 may be therefore used for internal communications within the apparatus or for external communications with other devices.

When the apparatus 200 is configured to implement some functionality, some component and/or components of the apparatus 200, such as for example the at least one processor 202 and/or the at least one memory 204, may be configured to implement this functionality. Furthermore, when the at least one processor 202 is configured to implement some functionality, this functionality may be implemented using the program code 206 comprised, for example, in the at least one memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 200 comprises means for performing at least one example embodiment described herein. In one example, the means comprises the at least one processor 202, the at least one memory 204 including program code 206 configured to, when executed by the at least one processor, cause the apparatus 200 to perform the example embodiment(s).

The apparatus 200 may comprise for example a computing device such as for example a server. Although apparatus 200 is illustrated as a single device it is appreciated that, wherever applicable, functions of the apparatus 200 may be distributed to a plurality of devices, for example to implement example embodiments as a cloud computing service.

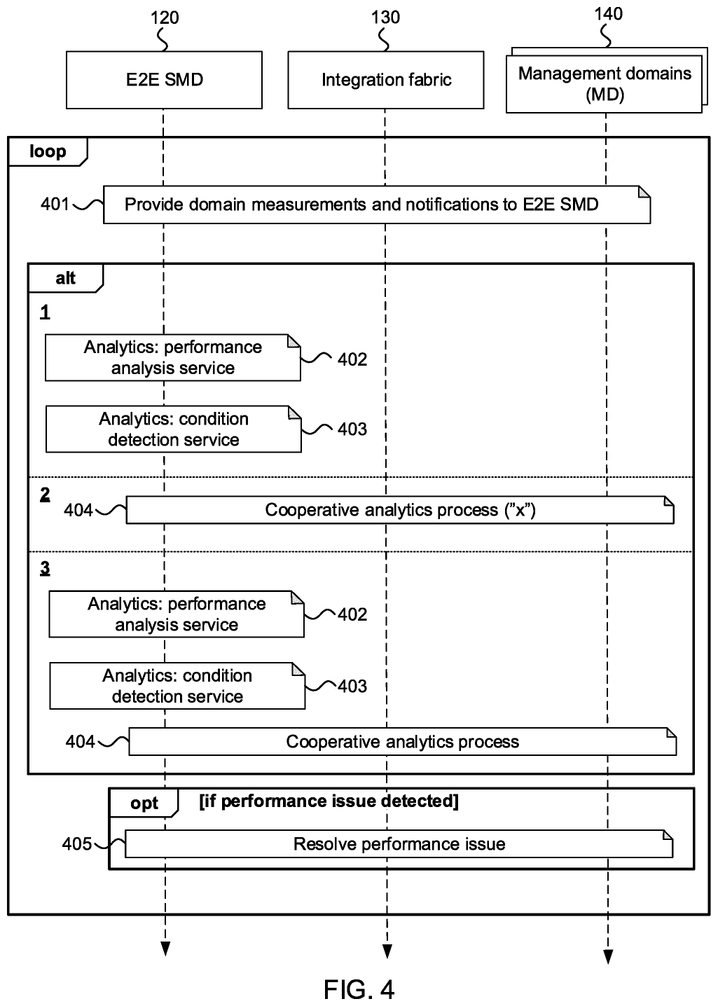

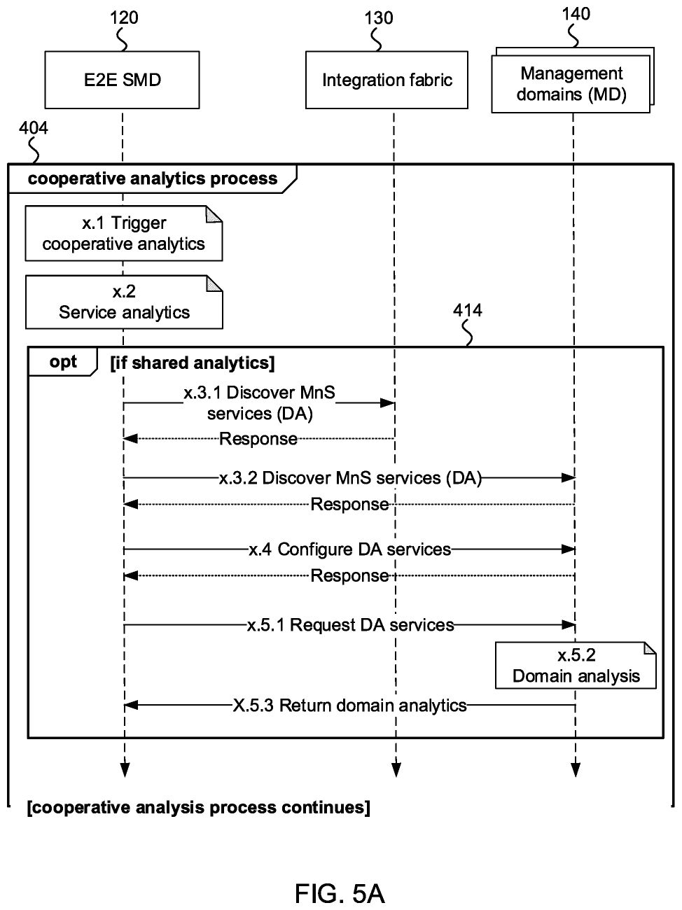

FIG. 3 illustrates an example of a multi-domain assurance management architecture, according to an example embodiment. The disclosed framework for cooperative analytics enables the centralized service management domain, for example the E2E SMD 120, to coordinate the service assurance analytics together with the management domains 140 when analysing performance data to detect performance issues. The cooperative process may comprise a multi-domain analytics process with analytics entities in both the E2E SMD 120 and the management domains 140. Therefore, the E2E SMD 120 may comprise a cooperative analytics function 122. The cooperative analytics function 122 may communicate with the management domains 140 via any suitable communication interface(s) such as communication interface 208. The cooperative analytics function 122 may communicate with one or more of the management domains 140 directly. Alternatively, or additionally, the cooperative analytics function 122 may communicate with one or more of the management domains 140 via a cross-domain integration fabric or management domain specific integration fabrics, as will be further discussed for example with reference to FIG. 4.

One or more of the management domains 140 may include at least one analytics function 146. The analytics function 146 may perform data analytics within the respective management domain, for example to detect communication performance issues, for example with respect to amount of packet losses, latency, jitter, etc, for one or more communication services. The analytics function 146 may receive request(s) to perform analytics at the respective management domain (MD analytics) from the cooperative analysis function 122, or in general the E2E SMD 120. The analytics function 146 may provide results of the management domain analytics to the cooperative analytics function 122.

One or more of the management domains 140 may include at least one data collection function 148. The data collection function 148 may collect data from the respective management domain and provide the collected data to its internal analytics function 146. The collected data may be called domain data or management domain data. The data collection function 148 may also collect data at the respective management domain for the cooperative analytics function 122. The data collection function 148 may receive request(s) to perform data collection service(s) at the respective management domain from the cooperative analysis function 122. The data collected by the data collection function may include any data that is characteristic of the respective management domain. For example, for the RAN MD 141, the data may comprise radio coverage report(s), for example based on received signal strength distribution within a coverage area of a cell. Such information may be used for example by the E2E SMD 120 or the analytics function 146 to identify whether a drop in throughput is due to insufficient radio signal quality. The collected data may also comprise resource utilization or resource demand data, for example to gather information about the actual demand of resources for a specific service in certain cells. Such information may be used by the E2E SMD 122 or the analytics function 146 to identify whether a decrease in throughput is due to an overload situation. The data collection function may collect the data from respective network resources 150. It is noted that the data provided to the cooperative analysis function 122 by the analysis function 146 may comprise analysis results, e.g. identification of one or more performance issues, whereas the data provided by the data collection function 148 may comprise raw measurement data without any analysis.

Upon reception of measurement data or problem report data, the E2E SMD 120 may trigger the cooperative analytics process, e.g. by initiating the cooperative analytics function 122 that may be configured to manages the cooperative analytics process. When the management domains 140 observe something, the management domains 140 may share their analytics results with the cooperative analytics function 122. Based on the analytics results, the cooperative analytics function 122 may determine to trigger the analytics function(s) 146 of the management domains 140 to undertake subsequent analytics in the respective management domains. Based on the analytics results, the cooperative analytics function 122 may further determine to trigger the data collection function(s) 148 of the management domains 140 to collect further data. Effectively, the cooperative analytics services may involve a subprocess through which the E2E SMD 120 may coordinate relevant management domains to undertake analysis, for example through at least one integration fabric. The following functionality may be supported:
The service management domain (e.g. the E2E SMD 120) may trigger cooperative analytics together with one or more of the management domains 140 to cooperatively evaluate the performance issue(s). This enables to improve reconfiguration of the multi-domain communication network to address any performance issues.
The cooperative analysis process may be distributed to multiple management domains to concurrently undertake their respective analytics. This enables to speed up the cooperative analysis process.
The management domain analytics may be followed by subsequent service analytics at the service management domain to detect the performance issue. This enables the individual analytics results and the data provided by the management domains 140 to be considered for detecting and/or solving the performance issue. This enables to improve service management in the multi-domain network.
The cooperative analysis may be applied for example to any service assurance analytics services. The cooperative analytics may be executed in addition, or as replacement, to performance analysis and condition detection services that are based on management domain specific analytics. This provides flexibility in the service management architecture of the multi-domain network.
The cooperative process may also be used to trigger measurements collection at one or more of the management domains. This enables coordinated reconfiguration of the data collected at the different management domains 140 and thereby the performance of the cooperative analytics may be improved.

FIG. 4 illustrates an example of a service quality management process, according to an example embodiment. The process may be conducted between the E2E SMD 120, the management domains 140, and optionally an integration fabric acting as an intermediary device or function between the E2E SMD 120 and the management domains 140. Functionality of the E2E SMD 120 may be implemented by the cooperative analytics function 122. An individual management domain may be associated with its own integration fabric, or, a cross-domain integration fabric may serve more than one management domain, for example all of the management domains 140 or a subset of the management domains 140. Therefore, even though some example embodiments have been described using a single integration fabric 130 as example, it is appreciated that similar functionality could be achieved also by using more than one integration fabric associated with respective one or more management domains. The operations 401 to 405 may be performed within a closed loop. Some of the operations may be optional or are provided as alternatives, as will be further described below.

At operation 401, the measurement domains 140 may provide performance information, such as for example domain measurements and/or notifications, to the E2E SMD 120. For example, performance events service(s) of the management domains 140 may provide notifications on performance events (e.g. threshold crossings) to the integration fabric 130. The integration fabric 130 may forward the notifications to the management functions of the E2E SMD 120 that have subscribed to the related data channels. Performance measurement streaming service(s) of the management domains 140 may provide streaming measurements to the integration fabric 130. The integration fabric 130 may forward the streaming measurements to the management functions in the E2E SMD 120 that have subscribed to the related data channels. Performance measurement collection service(s) of the management domains 140 may provide notifications related to the availability of batches of performance measurements to the integration fabric 130. The integration fabric 130 may forward the notifications related to the availability of batches of performance measurements to the management functions in the E2E service management domain that have subscribed to the related data channels. The E2E SMD 120 may further obtain the collected batch of measurements from the management domains 140 using the respective performance measurements collection service. This enables the E2E SMD 120 to evaluate service performance based on the measurements and notifications received from the management domains 140.

At operation 402, the received performance information may be analysed internally with in the E2E SMD 120 by a set of one or more performance analysis services that depend on the E2E service management domain.

At operation 403, the performance information may be further analysed by a condition detection service to detect predetermined conditions in the performance information.

As illustrated in FIG. 4, the loop may comprise one of the following alternatives (“alt”): 1) the performance analysis service 402 and the condition detection service 403, 2) the cooperative analytics process 404, or 3) the performance analysis service 402, the condition detection service 403, or the cooperative analytics process 404. Hence, the cooperative analytics process 404 may be performed separately, or in combination with the performance analysis service 402 and/or the condition detection service 403. It is also possible to omit the cooperative analytics process 404, for example if the E2E SMD 120 determines that the detected performance issue(s) may be resolved without cooperative analytics.

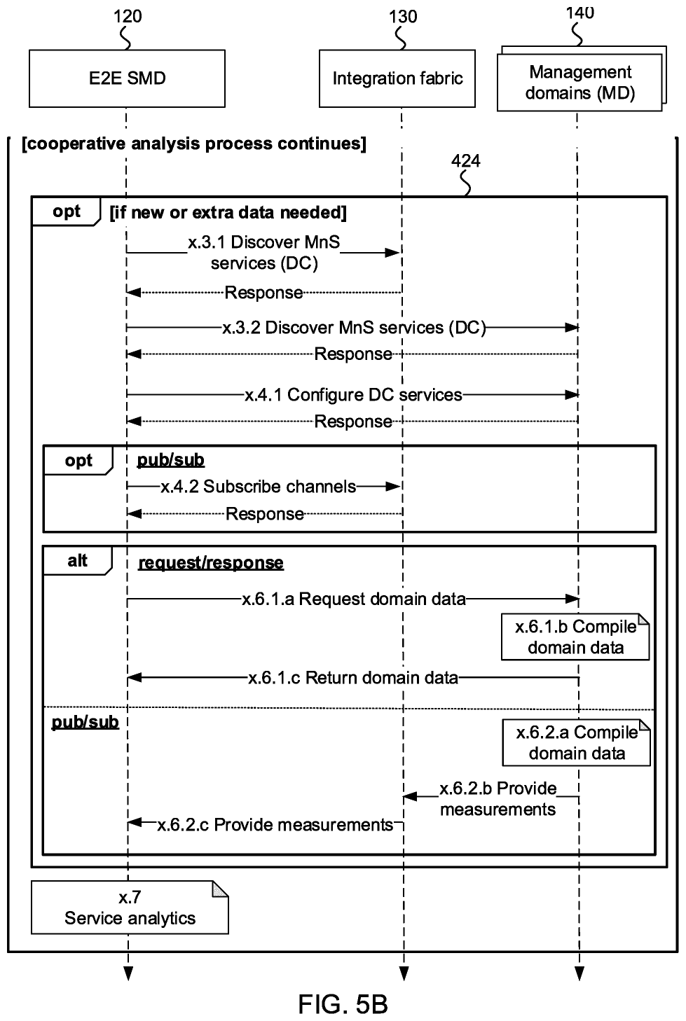

At operation 404, a cooperative analytics process may be performed among the E2E SMD 120, the management domains 140, and optionally the integration fabric 130. The cooperative analytics process 404 may be performed as described with reference to FIG. 3. Further example embodiments of the cooperative analytics process 404 are described with reference to FIG. 5A and FIG. 5B.

At operation 405, the performance issue(s) may be resolved. For example, if a performance issue is detected, the E2E SMD 120 may attempt to resolve the issue itself or it may escalate the issue via the integration fabric 130 for resolution by the ZSM framework consumer(s) 110. The management domains 140 may also perform independent analytics by their respective analytics functions 146. The management domains 140 may therefore provide their own analytics services whose results may be used internally at the management domains 140 for assurance services or be provided to authorized external consumers, for example the E2E SMD 120. The cooperative analytics process 404 enables assembling a shared cross-domain perspective or insight from the different management domains 140, for example to improve resolving of the performance issue(s).

FIGS. 5A and 5B illustrate an example of a cooperative analytics process, according to an example embodiment. The flow within the cooperative analytics process 404 is represented by referring to operations “x”. Note that this example is provided for the case, where the cooperative analytics process 404 replaces the performance analysis service 402 and the condition detection service 403. However, as noted above, the cooperative analytics process 404 may be alternatively executed in addition to these services.

At operation x.1, the cooperative analytics process 404 may be triggered based on an initial analysis at the E2E SMD 120. The initial analysis may comprise determining, by the E2E SMD 120, that cooperative analytics is needed. Such determination may for example be derived from service metrics that indicate a performance issue coming from one of many sources. The service metrics may be received from the management domains 140. An example of a performance issue may be the observation of too many packet losses, which could be due to problems on the transport link, due to congestion on the access radio link and thus infrequent scheduling, or due to issues in the cloud resources. Appropriate analysis of such an issue may benefit from collaborative analysis from multiple management domains 140 and therefore E2E SMD 120 may trigger the cooperative analytics process 404. In general, the cooperative analytics process 404 may be triggered by detecting a triggering condition indicative of communication performance issue(s) at the communication network. The E2E SMD 120 may be for example configured with a list of performance issues optionally associated with criteria for triggering the cooperative analytics.

At operation x.2, E2E SMD 120, may perform service analytics to determine the particular analytics that is needed. In general, the service analytics may provide as a result a notification of a service quality violation, for example, in case of too many packet losses, lower achievable throughput, higher blocking or rejection of new service requests, etc. The service analytics may however further involve analysing service data such as performance parameters of the service, e.g. latency, jitter, or number of connected users, to determine whether the service quality violation or a performance issue is likely to be due to scheduling delays or other challenges. Service analytics may determine that multiple management domains 140 need to be considered for the cooperative analytics process 404 or for collecting new data or more data. The service analytics may therefore determine the management domain analytics needed, for example based on a type of the performance issue(s). Furthermore, the E2E SMD 120 may be configured with a mapping of the types of performance issues, or combinations thereof, to particular management domains 140 and/or analytics to be requested. In response to determining that shared analytics between multiple management domains 140 are needed, one or more of the optional (“opt”) operations 414 (x.3.1, x.3.2, x.4, x.5.1, x.5.2, x.5.3) may be performed.

At operation x.3.1 (414), the E2E SMD 120 may discover data analysis (DA) services available at the management domains 140. Data analysis service is one type of management service (MnS). The discovery enables the E2E SMD 120 to identify the analytics to be requested or fetched. The E2E SMD 120 may therefore interact with the integration fabric 130 (a cross-domain integration fabric or integration fabrics of the management domains 140) to identify or discover the potential analytics services from the management domains 140 that are appropriate for the required analysis. For example, the E2E SMD 120 may send a discovery message to the integration fabric 130, which may respond to the discovery message by indicating the available DA services at respective management domain(s) 140. The discovery may be performed with respect to the management domain(s) 140 identified at operation x.2. This enables to reduce the amount of unnecessary discovery operations. The outcome of the discovery process may be that one or more analytics services are discovered as potential candidates for performing management domain data analytics.

At operation x.4, the E2E SMD 120 may configure the management domain data analytics, for example before the analytics are requested or fetched. The E2E SMD 120 may send a configuration of the management domain analytics to the management domains 140. It is however noted that the configuration may be sent to one or a subset of the management domains 140, for example management domain(s) 140 from which further analytics service(s) are requested in order to perform the cooperative analytics. The relevant management domains 140 may respond to the configuration sent by the E2E SMD 120, for example by acknowledging the received configuration.

At operation x.5.1, the E2E SMD 120 may request management domain analytics service(s) from at least one of the management domains 140. It is noted that the cooperative analytic process may be partially based on domain analytics requested and performed before initiation of the cooperative analytics process 404. This enables results of earlier management domain analytics to be improved by cooperative analytics. For example, the E2E SMD 120 may detect a problem in one domain, e.g. the core MD 144, but it may determine that new analytics and/or data are needed from different domain(s), e.g. the RAN MD 141. The E2E SMD 120 may then trigger the other management domain (e.g. RAN) to perform related measurements and/or analytics. Consider for example the case where the core network reports some throughput decrease for a service. The E2E SMD 120 may determine that there could be different sources of the problem leading to reduced throughput in the RAN. Therefore, the E2E SMD 120 may ask the RAN MD 141 for the related measurements and/or analytics. This enables the performance issue to be resolved more effectively at the E2E SMD 120. For example, based on the additional data and/or analytics, as well as the data from the core network, the E2E SMD 120 is enabled to better differentiate radio-related problems from load-based problems and to mitigate the performance issue accordingly.

The management domain analytics may be requested in response to detecting a triggering condition indicative of communication performance issue(s) at the communication network. Alternatively, or additionally, the management domain analytics may be requested according to a predetermined schedule and/or in response to detecting expiry of a timer. For example, the cooperative analytics may be scheduled to be performed periodically, e.g. with a period of minute(s), hour(s), or day(s), or at irregular time intervals. Alternatively, a timer may be applied to ensure that the cooperative analytics are carried out sufficiently often. For example, the timer may be set to an initial value, which may be equal to maximum desired time between successive cooperative analytics. The timer may be initiated in response to performance of the cooperative analytics. The cooperative analytics may be initiated in response to detecting expiry of the timer. However, in combination with the predetermined schedule, the timer may be applied to avoid the cooperative analytics to be performed too often. For example, the timer may be set to an initial value, which may be equal to a minimum desired time between successive cooperative analytics. The cooperative analytics function 122 may refrain from initiating cooperative analytics until expiry of the timer. For example, if cooperative analytics are carried out in response to detecting a performance issue or other unscheduled event, performance of subsequent cooperative analytics scheduled right after the performed analytics may be avoided. This enables to avoid unnecessary resource consumption in the communication network. The initial time of the timer may therefore be indicative of both a maximum and a minimum time between successive instances of the cooperative analytics. The example embodiments described herein enable the cooperative analytics to be performed reactively, for example in response to a performance issue, and/or proactively, for example based on expiry of the timer, a predetermined schedule, or in general an internal decision in the E2E service management domain. The proactive cooperative analytics enables to find hidden anomalies which may not be yet detectable as performance issues.

The management domain analytics may be requested from the management domain(s) 140 identified at operation x.3.1 (414) or x.3.2 (414). The E2E SMD 120 may therefore send a request for the management domain analytics to the relevant management domain(s) 140. The request may be sent directly to the relevant management domain(s) 140 or to the integration fabric 130, if the integration fabric 130 supports request routing or service mesh functionality. The integration fabric 130 may forward the request to the relevant management domain(s) 140.

At operation x.5.2, the relevant management domain(s) 140 may perform management domain analytics, for example with their respective analytics function(s) 146. The respective analytics function(s) 146 may for example compute and/or generate analytics as requested by the E2E SMD 120.

At operation x.5.3, the relevant management domain(s) 140 may return the domain analytics. For example, after compiling the analytics results, the relevant management domain(s) 140 may send the analytics results to the E2E SMD 120, for example directly or via the integration fabric 130. The cooperative analysis process 404 may then proceed to FIG. 5B.

The operations x.3 and x.4 described above may be also performed if new data (e.g. new performance indicators or parameters) or more data (e.g. more measurement for already configured performance indicators or parameters) is needed from any of the management domains 140, for example to discover, configure, request, generate, and/or report domain data. In response to determining that more data is needed, one or more of the optional (“opt”) operations 424 (x.3.1, x.3.2, x.4.1, x.4.2, x.6.1.a. x.6.1.b, x.6.1.c, x.6.2.a, x.6.2.b, x.6.2.c) may be performed.

At operations x.3.1 or x.3.2 (424) the E2E SMD 120 may discover, directly or via the integration fabric 130, data collection (DC) service(s) available for collecting the management domain data from one or more of the management domains 140. Data collection service is another type of management service (MnS). The set of management domains for data collection may be the same as the set of management domains for the domain analytics (cf. operations 414). The integration fabric 130 or the relevant management domains 140 may respond to the discovery, for example by sending an indication of the available data collection service(s) at respective management domains 140.

At operation x.4.1, the E2E SMD 120 may configure the data collection service(s). For example, the E2E SMD 120 may send a configuration of the data collection service(s) to the relevant management domain(s) 140. This may be done prior to receiving the collected data from the management domain(s) 140, for example as part of operations x.6.1.c or x.6.2.c.

At operation x.4.2, if a publish/subscribe mechanism is used for the data collection, the E2E SMD 120 may subscribe to the relevant data channel(s), for example data channel(s) identified during the discovery at operation x.3.1 or x.3.2 (424). The integration fabric may respond, for example by acknowledging the subscription to the requested data channel(s). Data collection based on the publish/subscribe mechanism may further comprise compiling the domain data (operation x.6.2.a) at relevant management domain(s) 140. The management domain(s) 140 may provide the compiled management domain data (e.g. measurements) to the integration fabric 130 (operation x.6.2.b), which may forward the management domain data to the E2E SMD 120 (operation x.6.2.c). The E2E SMD 120 may therefore subscribe to the data channel(s) provided by the integration fabric 130 and receive the management domain data from the integration fabric 130 via the subscribed data channel(s).

Alternatively, the data may be collected directly from the relevant management domains 140, for example using a request/response mechanism. Hence, the subscription operation x.4.2 may be avoided. The E2E SMD 120 may send a request for the management domain data (operation x.6.1.a) to the relevant management domain(s) 140. The relevant management domain(s) 140 may compile their management domain data (operation x.6.1.b) and return the management domain data (x.6.1.c) to the E2E SMD 120. The E2E SMD 120 may therefore request the management domain data from the relevant management domains 140 directly and receive the management domain data from these management domains.

According to an example embodiment, the management domain data may comprise updated management domain data. For example, performance indicator(s) of the updated management domain data may be different from previously collected management domain data. Alternatively, or additionally granularity of performance indicator(s) may be different from the previously collected management domain data. The E2E SMD 120 may for example detect a problem based on the current measurements or analytics received from a given management domain. Based on the detected problem, the E2E SMD 120 may determine that more data is needed and thus request the relevant management domain(s) 140 for more data. This updated request for management domain data could be targeted for other measurements or key performance indicators (KPI), or, for the same measurements or KPIs but at finer granularity. Granularity may refer for example to the time interval between measurements or a number of quantization levels for reporting the measurements. Hence, the additional data collection service may enable the cooperative analysis process to better handle the detected performance issue.

At operation x.7, the E2E SMD 120 may perform service analytics based on the received management domain analytics results and/or the management domain data. For example, the E2E SMD 120 may analyse the management domain analytics results in combination with the service data and/or service analytics of the E2E SMD 120 (or in general the service management domain). For example, if the E2E SMD 120 requested new data or data with finer granularity from the management domains 140 based on the detected problem (e.g. congestion, packet loss, etc.) at service level, the E2E SMD 120 may analyse the service problem related performance indicators along with the newly received data from the management domains 140 to perform root cause analysis. Another example could be, if the E2E SMD 120 requested data from one management domain like the RAN MD 141 based on some analysis done on another management domain like the Core MD 144, the E2E SMD 120 may combine the information from both domains to perform the root cause analysis at the service level. The service analytics may be used to resolve the detected performance issue(s). For example, based the results of the analysis, E2E SMD 120 may determine how to reconfigure the communication network to solve or mitigate the performance issue(s). The E2E SMD 120 may then cause the reconfiguration, for example by distributing reconfiguration information to relevant network devices or functions within the communication network.

Example embodiments of the present disclosure may thus enable coordination of analytics services between the service management domain and the individual management domains 140. The disclosed methods for enabling coordination between the different entities helps to better analyse service problems that require E2E SMD 120 to fetch, correlate and analyse data from multiple management domains 140 or to enrich the reported data, performance indicators, or analytics from one or more management domains 140 for better root cause analysis of the identified problems. Overall efficiency of the communication network may be therefore improved.

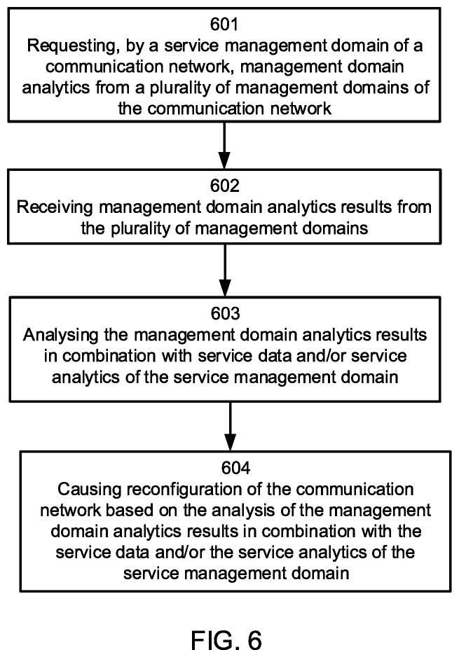

FIG. 6 illustrates an example of a method for cooperative service analytics, according to an example embodiment.

At 601, the method may comprise requesting, by a service management domain of a communication network, management domain analytics from a plurality of management domains of the communication network.

At 602, the method may comprise receiving management domain analytics results from the plurality of management domains.

At 603, the method may comprise analysing the management domain analytics results in combination with service data and/or service analytics of the service management domain.

At 604, the method may comprise causing reconfiguration of the communication network based on the analysis of the management domain analytics results in combination with the service data and/or the service analytics of the service management domain

Further features of the method directly result for example from the functionalities and parameters of the apparatus 200, the E2E SMD 120, the integration fabric(s) 130, or one or more of the management domains 140, as described in the appended claims and throughout the specification, and are therefore not repeated here. Different variations of the methods may be also applied, as described in connection with the various example embodiments.

An apparatus, for example a network device or a network node, may be configured to perform or cause performance of any aspect of the methods described herein. Further, a computer program may comprise instructions for causing, when executed, an apparatus to perform any aspect of the methods described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1.-34. (canceled)

35. An apparatus, comprising:
at least one processor; and
at least one memory including computer program code, the at least one memory and the computer code configured to, with the at least one processor, cause the apparatus at least to:
request, by a service management domain of a communication network, management domain analytics from a plurality of management domains of the communication network;
receive management domain analytics results from the plurality of management domains;
analyse the management domain analytics results in combination with service data and/or service analytics of the service management domain; and
cause reconfiguration of the communication network based on the analysis of the management domain analytics results in combination with the service data and/or the service analytics of the service management domain.

36. The apparatus according to claim 35, wherein the at least one memory and the computer code are further configured to, with the at least one processor, cause the apparatus to:
request the management domain analytics from at least one of the plurality of management domains based on a predetermined schedule and/or in response to detecting expiry of a timer.

37. The apparatus according to claim 35, wherein the at least one memory and the computer code are further configured to, with the at least one processor, cause the apparatus to:
request the management domain analytics from at least one of the plurality of management domains in response to detecting a triggering condition indicative of at least one communication performance issue at the communication network.

38. The apparatus according to claim 37, wherein the at least one memory and the computer code are further configured to, with the at least one processor, cause the apparatus to:
determine the management domain analytics based on a type of the at least one communication performance issue.

39. The apparatus according to claim 36, wherein the at least one memory and the computer code are further configured to, with the at least one processor, cause the apparatus to:
send a configuration of the management domain analytics to the at least one of the plurality of management domains.

40. The apparatus according to claim 36, wherein the at least one memory and the computer code are further configured to, with the at least one processor, cause the apparatus to:
send a request for the management domain analytics to the at least one of the plurality of management domains.

41. The apparatus according to claim 36, wherein the at least one memory and the computer code are further configured to, with the at least one processor, cause the apparatus to:
discover the management domain analytics via at least one integration fabric associated with the plurality of management domains.

42. The apparatus according to claim 41, wherein the at least one memory and the computer code are further configured to, with the at least one processor, cause the apparatus to:
send a request for the management domain analytics to the at least one integration fabric.

43. The apparatus according to claim 41, wherein the at least one memory and the computer code are further configured to, with the at least one processor, cause the apparatus to:
collect, from the at least one of the plurality of management domains, management domain data associated with the at least one communication performance issue; and
cause the reconfiguration of the communication network further based on the management domain data.

44. The apparatus according to claim 43, wherein the at least one memory and the computer code are further configured, with the at least one processor, to cause the apparatus to:
discover, via the at least one integration fabric associated with the plurality of management domains, at least one data collection service for the collection of the management domain data.

45. The apparatus according to claim 44, wherein the at least one memory and the computer code are further configured, with the at least one processor, to cause the apparatus to:
send a configuration of the at least one data collection service to the at least one of the plurality of management domain.

46. The apparatus according to claim 43, wherein the at least one memory and the computer code are further configured to, with the at least one processor, to cause the apparatus to:
subscribe to at least one data channel;
receive the management domain data from the at least one integration fabric via the at least one data channel.

47. The apparatus according to claim 43, wherein the at least one memory and the computer code are further configured, with the at least one processor, to cause the apparatus to:
request the management domain data from the at least one of the plurality of management domains; and
receive the management domain data from the at least one of the plurality of management domains.

48. The apparatus according to claim 43, wherein the management domain data comprises updated management domain data, wherein at least one performance indicator of the updated management domain data is different from previously collected management domain data, and/or wherein a granularity of the at least one performance indicator of the updated management domain data is different from the previously collected management domain data.

49. The apparatus according to claim 41, wherein the at least one integration fabric comprises a cross-domain integration fabric associated with the plurality of management domains or a plurality of integration fabrics associated with respective management domains.

50. The apparatus according to claim 35, wherein the plurality of management domains comprises at least one of: a radio access network management domain, a fixed access management domain, a transport management domain, a core network management domain, or a cloud management domain.

51. A method comprising:
requesting, by a service management domain of a communication network, management domain analytics from a plurality of management domains of the communication network;
receiving management domain analytics results from the plurality of management domains;
analysing the management domain analytics results in combination with service data and/or service analytics of the service management domain; and
causing reconfiguration of the communication network based on the analysis of the management domain analytics results in combination with the service data and/or the service analytics of the service management domain.
